(19) United States
(12) Patent Application Publication
(10) Pub. No.: US 2026/0324610 A1
(43) Pub. Date: Oct. 22, 2026

(54) FISHING REEL AND CONTROL METHOD THEREOF

(71) Applicant: Ningbo Yongjie Fishing Gear Co., Ltd., Cixi City (CN)

(72) Inventors: Zuhang FANG, Cixi City (CN); Zhaozhou SHI, Cixi City (CN)

(21) Appl. No.: 19/404,608

(22) Filed: Dec. 1, 2025

(30) Foreign Application Priority Data
Apr. 19, 2025 (CN) 202510493848.0

(51) Int. Cl. A01K 89/033; A01K 89/0155

(52) U.S. Cl. CPC A01K 89/033; A01K 89/01555

(57) ABSTRACT

Provided herein is a fishing reel and a control method thereof, comprising a reel body, a spool, an electric control board and an electromagnetic assembly; the electromagnetic assembly is used to generate a driving force, and the electric control board can control a driving current in an electric module so that it interacts with a magnetic module to form a driving force, which acts on the spool to cause the spool to generate acceleration; a mechanical control module is also provided on the reel body, and includes at least a main operation key and a secondary operation key; the process of rotating the spool to release the line is divided into a plurality of interval sections, which include at least a front section, a middle section and a rear section; the mechanical control module can individually adjust the driving force generated by the electromagnetic assembly in each interval section.

### CROSS-REFERENCE TO RELATED APPLICATIONS

This application claims priority under 35 U.S.C. § 119(a) to Chinese Patent Application No. 202510493848.0, filed on Apr. 19, 2025, which is hereby incorporated by reference herein in its entirety.

### TECHNICAL FIELD

The disclosure relates to the field of fishing reels, and in particular to a fishing reel and a control method thereof.

### BACKGROUND ART

A fishing reel, also known as a line release or reel, or in ancient times, a fishing cart, is an essential tool for casting fishing rods. It is primarily fixed in front of the rod handle. During casting, the bait flies due to inertia, pulling the fishing line out of the reel outlet, driving the reel to rotate and release the line. The speed of the bait is reduced by air resistance and line friction. When the speed of the reel releasing the line due to inertia is greater than the speed at which the line is pulled out of the reel outlet, some of the line is retained inside the reel, forming a floating line, which can lead to line tangling. Therefore, existing fishing reels are typically equipped with a device that brakes and slows down the reel to prevent the line from tangling when casting.

Devices that rely on electromagnetic induction effect to brake the fishing reel's spool have begun to appear on the market. The principle of this braking device is to rely on the rotor magnet set on the spool shaft and the stator coil set on the side shell of the fishing reel. The two generate electromagnetic induction when they rotate relative to each other to perform braking. This type of electromagnetic brake fishing reel is generally equipped with an operation button to control the braking force of the electromagnetic brake assembly.

With the continuous development of fishing reel related technologies, existing fishing reels are no longer limited to the simple line-reeling function, but begin to develop in the direction of multi-functions. As the functions increase, the original single operation key can no longer meet the requirements of multi-function control. Therefore, this type of multi-function fishing reel will be equipped with a Bluetooth component to realize the control and adjustment of the fishing reel through external communication equipment.

The Chinese patent application number CN117562026A discloses: “A multifunctional continuously variable electromagnetic fishing reel and its control method, including a fishing reel body and a spool; the spool is rotatably connected to the fishing reel body through a rotating shaft, and the fishing reel body is also provided with a rocker arm that is transmission-connected to the rotating shaft; it also includes: a spool self-rotating assembly, which includes a stator coil, a power module and a control module arranged in the fishing reel body, and a mover magnet connected to the rotating shaft; the stator coil and the power module are both electrically connected to the control module, and the power module transmits current to the stator coil through the control module; the control module can control the current direction and current magnitude supplied by the power module to the stator coil, thereby changing the rotation direction and rotation speed of the spool relative to the fishing reel body; the disclosure can realize arbitrary control of the direction and speed of the spool, thereby realizing the control basis for the multifunctionalization of the electromagnetic fishing reel.”

However, including the solutions described in the above-mentioned patents, there is a problem with such multifunctional fishing reels currently available on the market. That is, the original electromagnetic brake fishing reels have relatively single functions, so function control can be achieved through a single operation key, which causes users to develop corresponding usage habits after using them for a long time. However, since the existing multifunctional fishing reels need to use external communication equipment for operation and control in order to control and adjust all functions in detail, many users are not used to it. What's more, some users are not proficient in operating external communication equipment and cannot use such multifunctional fishing reels normally. There is also a problem with fishing reels that can only be adjusted using external communication equipment. That is, the external communication equipment cannot be operated during the casting process. Therefore, each adjustment of the fishing reel function needs to be completed before the casting begins, and it is not possible to adjust according to the feedback feel while casting, which also causes inconvenience in use.

### SUMMARY

In order to overcome the shortcomings of the prior art multifunctional fishing reel that requires the use of external communication equipment to control and adjust all functions in detail, which violates the usage habits of some users and makes its operation inconvenient, the disclosure provides a fishing reel and a control method thereof.

The technical solution of the disclosure to solve the technical problem is: a fishing reel, comprising:
reel body;
a spool, rotatably disposed within the spool body;
an electric control panel is provided on one side of the reel body;
an electromagnetic assembly for generating a driving force, comprising a magnetic module and an electric module, wherein the magnetic module is connected to the spool, and the electric module is disposed within the spool body and electrically connected to an electric control board. The electric control board is capable of controlling a driving current within the electric module so that it interacts with the magnetic module to generate the driving force. The driving force acts on the spool, causing the spool to generate acceleration.

When the electromagnetic component applies a positive driving force to the spool, the spool can generate a positive acceleration to promote the rotation of the spool.

When the electromagnetic component applies a reverse driving force to the spool, the spool can generate a reverse acceleration to suppress the rotation of the spool.

The reel body is further provided with a mechanical control module, which includes at least a main operation key and a secondary operation key. The main operation key and the secondary operation key are responsive to the user's manipulation actions, and the mechanical control module is controlled and connected to the electric control board, so that the user can adjust the driving force generated by the electromagnetic assembly by operating the main operation key and/or the secondary operation key.

Rotating the spool to pay off the line is divided into a plurality of sections, which at least include a front section and a back section.

The mechanical control module can individually adjust the driving force generated by the electromagnetic components in each interval segment.

Furthermore, the process of the spool rotating to pay off the line also includes a middle section.

Furthermore, the first way to divide the various interval segments is as follows: the process of the spool rotating to pay off the line is divided into various interval segments according to the change of the spool speed, wherein the interval segment from 0 rpm to the maximum speed Arpm of the spool is the front segment, the interval segment from the maximum speed Arpm of the spool is attenuated to m %. Arpm of the spool is the middle segment, and the interval segment from m %. Arpm of the spool is attenuated to n %·Arpm of the spool is the back segment, and n≤m≤100 is satisfied.

Furthermore, the second way of dividing the various interval segments is as follows: the process of the spool rotating and paying off is divided into the various interval segments according to the rotation time of the spool, wherein the interval segment from 0 s to X s of the spool rotating and paying off is the front segment, the interval segment from X s to Y s of the spool rotating and paying off is the middle segment, and the interval segment from Y s to Z s of the spool rotating and paying off is the back segment, and 0≤X≤Y≤Z is satisfied.

Furthermore, a third way of dividing the various interval segments is as follows: the process of the spool rotating and paying out the line is divided into the various interval segments according to the paying-out distance of the fishing line, wherein the interval segment from Om to am of the fishing line being paid out by the spool rotating and paying out the line is the front segment, the interval segment from am to βm of the fishing line being paid out by the spool rotating and paying out the line is the middle segment, and the interval segment from βm to γm of the fishing line being paid out is the back segment, and 0≤α≤β≤γ is satisfied.

Furthermore, the mechanical control module also includes a main control element and a sub-control element integrated on the electric control board; the main operation key forms a transmission connection with the main control element, and the sub-operation key forms a transmission connection with the sub-control element, so that the electric control board is controlled by the main operation key and the sub-operation key; the main control element can control the driving current in the power module under one or more of the several sections, and the sub-control element respectively controls the driving current in the power module under one of the several sections.

Furthermore, a transmission member is provided between the main operating member and the main control element, and between the auxiliary operating member and the auxiliary control element. The transmission member can be configured as a rigid connecting column, an elastic connecting torsion spring or a magnetic block; the main control element can be configured as a potentiometer, a knob encoder or a magnetic sensor.

When the transmission member is configured as a rigid connecting column or an elastic connecting torsion spring, the main control element and the auxiliary control element are configured as a potentiometer or a knob encoder.

When the transmission member is configured as a magnetic block, the main control element and the auxiliary control element are configured as magnetic sensors.

Furthermore, an electronic control module is also provided in the reel body, and the electronic control module can establish communication connection with an external communication device. The user can control the electronic control board by operating the external communication device, and then adjust the driving force of the electromagnetic component through the electronic control board.

Furthermore, the main operation key and/or the auxiliary operation key are configured as knobs, dial wheels or levers exposed on the surface of the reel body.

The disclosure also includes a first control method, which is applicable to the above-mentioned fishing reel, and further includes the following manner:

S10, adjusting the driving force of all sections: operating the main operation key on the reel body to achieve overall adjustment of the driving force of the electromagnetic assembly in each section during the spool rotation and pay-off process;

S11, fine-tuning the driving force of the front section: the auxiliary operation keys on the reel body to achieve, based on the driving force set in S10, a separate fine-tuning of the driving force of the electromagnetic component in the front section during the spool rotation and pay-off process;

S12, fine-tuning the rear driving force: operate another auxiliary operation key on the reel body to achieve separate fine-tuning of the electromagnetic component driving force of the rear section during the spool rotation and pay-off process based on the driving force set in S10.

The disclosure also includes a second control method, which is applicable to the above-mentioned fishing reel, and further includes the following manner:

S20, adjusting the driving force of the middle section: operating the main operation key on the reel body to achieve separate adjustment of the driving force of the electromagnetic component in the middle section during the rotation and pay-off of the spool;
the auxiliary operation keys on the reel body to achieve separate adjustment of the driving force of the electromagnetic component in the front section during the spool rotation and pay-off process;
auxiliary operation key on the reel body to achieve separate adjustment of the electromagnetic component driving force of the rear section during the spool rotation and pay-off process.

The disclosure also includes a third control method, which is applicable to the above-mentioned fishing reel, and further includes the following manner:

S30, adjusting the driving force of all sections: operating the main operation key on the reel body to achieve overall adjustment of the driving force of the electromagnetic assembly in each section during the spool rotation and pay-off process;

S31, fine-tuning the driving force of the front section: operating one of the auxiliary operation keys on the reel body to achieve, based on the driving force set in S10, a separate fine-tuning of the driving force of the electromagnetic component in the front section during the spool rotation and pay-off process;

S32, Drive mode adjustment: The electric control panel is equipped with several drive modes, and each drive mode corresponds to a preset spool rotation and pay-off process. By operating another auxiliary operation key on the spool body, the electric control panel can be controlled to start the built-in drive mode and switch between the various drive modes. Under the corresponding drive mode, the braking force generated by the electromagnetic component in each interval section during the spool rotation and pay-off process can automatically change according to the setting, so that the spool rotates according to the pay-off process preset by the drive mode under the action of the electromagnetic component.

The beneficial effects of the disclosure are:
1. A mechanical control module is provided in the reel body. By operating the mechanical control module on the reel body, the fishing reel can be directly controlled and adjusted. Therefore, the fishing reel can be finely regulated without external communication equipment. In addition, due to the presence of the mechanical control module, the user can also control and adjust the fishing reel in real time during the casting process.
2. This fishing reel can individually adjust the driving force of the electromagnetic assembly in each section of the spool rotation and line-releasing process through the electronic control module and the mechanical control module. This allows the reel to independently regulate the front and back stages of the spool rotation and line-releasing process, making the braking mode of the reel more diverse, and thus making it possible to simulate the braking process of various types of fishing reels on the market by relying solely on this reel.
3. The mechanical control module includes a main operation key and a sub-operation key. The main operation key can be responsible for the overall adjustment of the spool rotation and line-releasing process, and can also be responsible for the separate adjustment of a certain interval in the spool rotation and line-releasing process. The sub-operation key can be responsible for the separate adjustment of one or several intervals in the spool rotation and line-releasing process, thereby making the control method of this fishing reel more diversified.

### BRIEF DESCRIPTION OF THE DRAWINGS

FIG. 1 is a schematic structural diagram of a first embodiment of the disclosure.

FIG. 2 is an exploded diagram of the first embodiment of the disclosure.

FIG. 3 is a cross-sectional view of the first embodiment of the disclosure.

FIG. 4 is a schematic structural diagram of a side cover in the first embodiment of the disclosure.

FIG. 5 is an exploded schematic diagram of the side cover in the first embodiment of the disclosure.

FIG. 6 is a schematic diagram of the front and back structures of the electric control board in the first embodiment of the disclosure.

FIG. 7 is a schematic diagram of a curve showing the braking stroke of the electromagnetic assembly in the fourth embodiment of the disclosure.

FIG. 8 is a schematic diagram of a curve showing the braking stroke of the electromagnetic assembly in the fifth embodiment of the disclosure.

FIG. 9 is a schematic diagram of a curve showing the braking stroke of the electromagnetic assembly in the sixth embodiment of the disclosure.

FIG. 10 is a schematic structural diagram of the side cover in the eighth embodiment of the disclosure.

FIG. 11 is a schematic structural diagram of a side cover in ninth embodiment of the disclosure.

FIG. 12 is a schematic structural diagram of the side cover in the tenth embodiment of the disclosure.

FIG. 13 is a schematic diagram of the arrangement of the transmission member in the eleventh embodiment of the disclosure.

FIG. 14 is a schematic diagram of the disassembly of the transmission member in the eleventh embodiment of the disclosure.

FIG. 15 is a schematic diagram of the disassembly of the transmission member in the twelfth embodiment of the disclosure.

FIG. 16 is a schematic diagram showing the arrangement of the first transmission member in the thirteenth embodiment of the disclosure.

FIG. 17 is a schematic diagram showing the position state change of the first transmission member in the twelfth embodiment of the disclosure.

FIG. 18 is a schematic diagram of the arrangement of the second transmission member in the twelfth embodiment of the disclosure.

FIG. 19 is a schematic diagram showing the position state change of the second transmission member in the twelfth embodiment of the disclosure.

FIG. 20 is a schematic diagram of the arrangement of the third transmission member in the twelfth embodiment of the disclosure.

FIG. 21 is a schematic diagram showing the position state change of the third transmission member in the twelfth embodiment of the disclosure.

Numbers in the figure: 1. Reel body; 2. Spool; 3. Electronic control board; 4. Magnetic module; 5. Electric module; 6. Mechanical control module; 7. Main operation key; 8. Auxiliary operation key; 9. Main control element; 10. Auxiliary control element; 11. Electronic control module; 12. Main body; 13. Side cover; 14. Transmission part; 15. Rigid connecting column; 16. Transmission gear; 17. Elastic connecting torsion spring; 18. Trigger block; 19. Magnetic block; 20. Mounting column; 21. Eccentric column; 22. Worm; a. Front section; b. Middle section; c. Rear section.

### DETAILED DESCRIPTION

The following will clearly and completely describe the technical solutions in the embodiments of the disclosure in conjunction with the accompanying drawings. Obviously, the described embodiments are only part of the embodiments of the disclosure, not all of the embodiments. Based on the embodiments of the disclosure, all other embodiments obtained by ordinary technicians in this field without making creative efforts are within the scope of protection of the disclosure.

It should be understood that although terms such as upper, middle, lower, top, end, etc. appear in this document to describe various elements, these elements are not limited by these terms. These terms are only used to distinguish elements from each other for ease of understanding, and are not used to define any direction or order limitation.

### Example 1

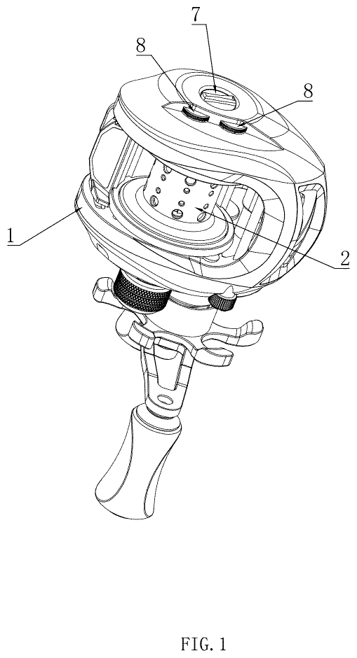

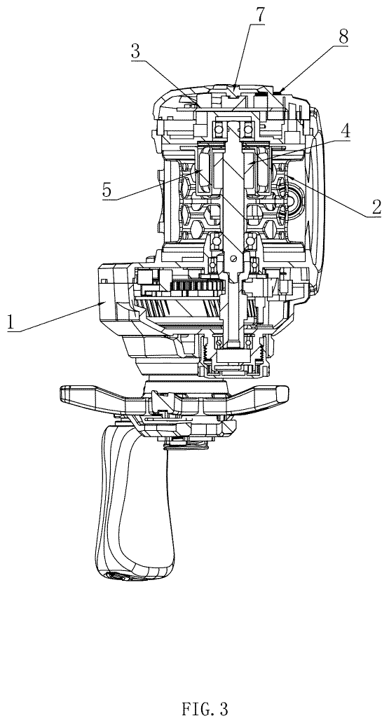

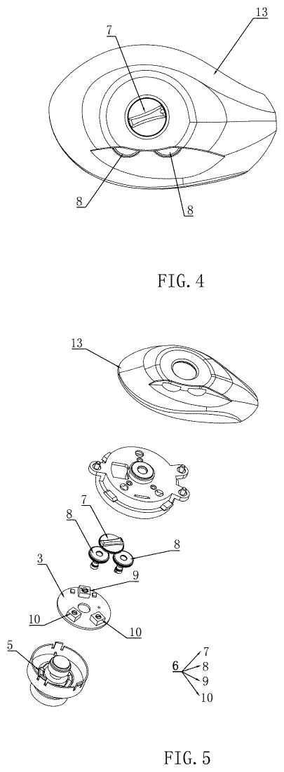

Referring to FIGS. 1 to 6, a fishing reel includes a reel body 1, a spool 2, an electric control board 3 and an electromagnetic assembly; the spool 2 is rotatably arranged in the reel body 1; the electric control board 3 is arranged on one side of the reel body 1; the electromagnetic assembly is used to generate a driving force, and the electromagnetic assembly includes a magnetic module 4 and an electric module 5, wherein the magnetic module 4 is connected to the spool 2, the electric module 5 is arranged in the reel body 1 and is electrically connected to the electric control board 3, the electric control board 3 can control the driving current in the electric module 5 so that it interacts with the magnetic module 4 to form the driving force, and the driving force acts on the spool 2 so that the spool 2 generates acceleration; a mechanical control module 6 is also provided on the reel body 1, and the mechanical control module 6 includes at least a main operation key 7 and a sub-operation key 8, and the main operation key 7 and the sub-operation key 8 respond to the user's control action, and the mechanical control module 6 forms a control connection with the electric control board 3, so that the user can operate the main operation key 7 and/or the sub-operation key 8 to adjust the driving force formed by the electromagnetic component; the process of rotating the spool 2 to pay off the line is divided into several interval segments, which include at least a front segment a, a middle segment b and a rear segment c; the mechanical control module 6 can separately adjust the driving force formed by the electromagnetic component under each interval segment.

In this embodiment, the process of the spool 2 rotating to pay off the line is divided into various intervals according to the change of the rotation speed of the spool 2, wherein the interval segment of the spool 2 rotation speed from 0 rpm to the maximum rotation speed Arpm is the front segment a, the interval segment of the spool 2 rotation speed from the maximum rotation speed Arpm to m %. Arpm is the middle segment b, and the interval segment of the spool 2 rotation speed from m %. Arpm to n %. Arpm is the rear segment c, and n≤m≤100 is satisfied.

One specific example of the division method of each interval segment in this embodiment is: the interval segment of the spool 2 speed from 0 rpm to the maximum speed of 40000 rpm is the front segment a, the interval segment of the spool 2 speed from the maximum speed Arpm to 50%·40000 rpm, that is, 20000 rpm is the middle segment b, and the interval segment of the spool 2 speed from 20000 rpm to 20%·40000 rpm, that is, 8000 rpm is the rear segment c.

In this embodiment, a speed detection component is further provided between the fishing reel body 1 and the spool 2, which monitors the speed of the spool 2 in real time and feeds back the monitored data to the electronic control board 3; in one implementation manner of the speed detection component, the speed detection component includes a Hall element and a timing element integrated on the electronic control board 3, and a magnet is provided on the spool 2, so that the rotation of the spool 2 is sensed by the Hall element, and the electronic control board 3 can calculate the speed of the spool 2 according to the rotation of the spool 2 and the rotation time.

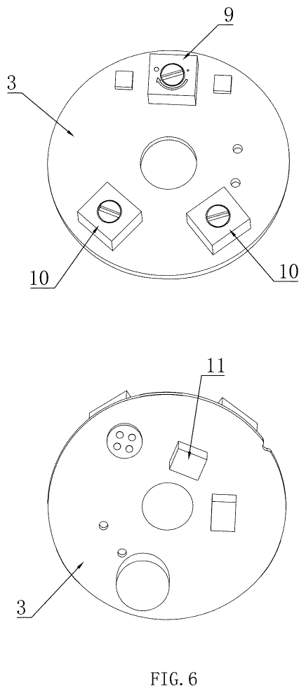

As shown in FIGS. 5 and 6, the mechanical control module 6 described in this embodiment also includes a main control component 9 and a sub-control component 10 integrated on the electric control board 3; the main operation key 7 forms a transmission connection with the main control component 9, and the sub-operation key 8 forms a transmission connection with the sub-control component 10, so that the electric control board 3 is controlled by the main operation key 7 and the sub-operation key 8; the main control component 9 can control the driving current in the power module 5 of one or more of the several sections, and the sub-control component 10 respectively controls the driving current in the power module 5 of one of the several sections.

As shown in FIG. 6, in this embodiment, an electronic control module 11 is further provided in the reel body 1. The electronic control module 11 can communicate with an external communication device. The user can control the electronic control board 3 by manipulating the external communication device, and then adjust the driving force of the electromagnetic component through the electronic control board 3.

In this embodiment, the electronic control module 11 includes a Bluetooth component integrated on the electronic control board 3.

As shown in FIGS. 1 to 5, the main operation key 7 in this embodiment is configured as a knob exposed on the surface of the reel body 1, and the auxiliary operation key 8 is configured as a dial exposed on the surface of the reel body 1; the main control element 9 and the auxiliary control element 10 are configured as potentiometers.

As shown in FIGS. 1 to 5, in this embodiment, two auxiliary operation keys 8 are configured.

As shown in FIGS. 1 to 5, in this embodiment, the main operation key 7 is disposed in the middle of the side cover 13, and the secondary operation key 8 is disposed near the edge of the side cover 13.

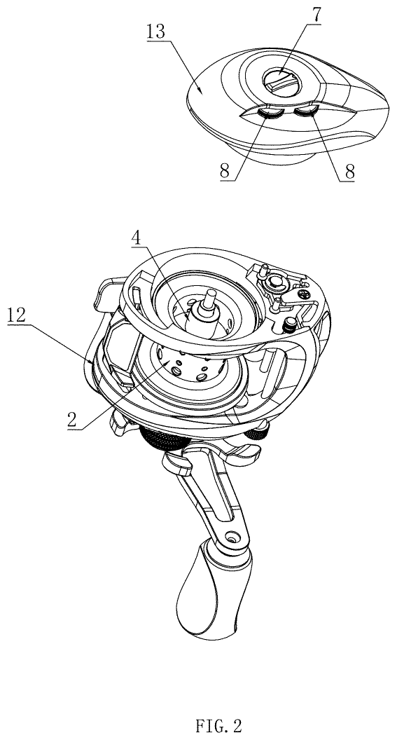

As shown in FIG. 2, in this embodiment, the reel body 1 includes a detachably connected main body 12 and a side cover 13, the electric control board 3, the mechanical control module 6 and the electronic control module 11 are all arranged on the side cover 13, the electric module 5 of the electromagnetic component is also arranged on the side cover 13, the spool 2 also includes a spool 2 shaft, the spool 2 is rotatably connected to the main body 12 of the reel body 1 through the spool 2 shaft, and the magnetic module 4 of the electromagnetic component is connected to the spool 2 shaft; since the side cover 13 is detachable and replaceable, a variety of side covers 13 with different built-in control modes can be designed and produced, so that users can replace the side cover 13 according to their needs to switch the control mode of the fishing reel.

### Example 2

The main differences between this embodiment and the first embodiment are:

In this embodiment, the division method of the various interval segments is as follows: the process of the spool 2 rotating to pay off the thread is divided into various interval segments according to the rotation time of the spool 2, wherein the interval segment from 0 s to X s when the spool 2 rotates to pay off the thread is the front segment a, the interval segment from X s to Y s when the spool 2 rotates to pay off the thread is the middle segment b, and the interval segment from Y s to Z s when the spool 2 rotates to pay off the thread is the back segment c, and 0≤X≤Y≤Z is satisfied.

One specific example of the division method of each interval segment in this embodiment: the process of the spool 2 rotating to pay off the line is divided into each interval segment according to the rotation time of the spool 2, wherein the interval segment from 0 s to 0.5 s when the spool 2 rotates to pay off the line is the front segment a, the interval segment from 0.5 s to 2 s when the spool 2 rotates to pay off the line is the middle segment b, and the interval segment from 2 s to 3 s when the spool 2 rotates to pay off the line is the back segment c.

The remaining structures and methods of this embodiment are consistent with those of the above-mentioned embodiment 1 and will not be described again here.

### Example 3

The main differences between this embodiment and the first embodiment are:

In this embodiment, the division method of each interval segment is as follows: the process of the spool 2 rotating to pay out the line is divided into each interval segment according to the pay-out distance of the fishing line, wherein the interval segment from 0 m to αm of the fishing line being paid out is the front segment a, the interval segment from am to βm of the fishing line being paid out by the spool 2 rotating to pay out the line is the middle segment b, and the interval segment from βm to γm of the fishing line being paid out is the back segment c.

One specific example of the division method of each interval segment in this embodiment: the process of the spool 2 rotating to release the line is divided into each interval segment according to the release distance of the fishing line, wherein the interval segment of 0 m to 5 m of the fishing line is the front segment a, the interval segment of 5 m to 45 m of the fishing line released by the spool 2 rotating to release the line is the middle segment b, and the interval segment of 45 m to 60 m of the fishing line released is the rear segment c.

The remaining structures and methods of this embodiment are consistent with those of the above-mentioned embodiment 1 and will not be described again here.

### Example 4

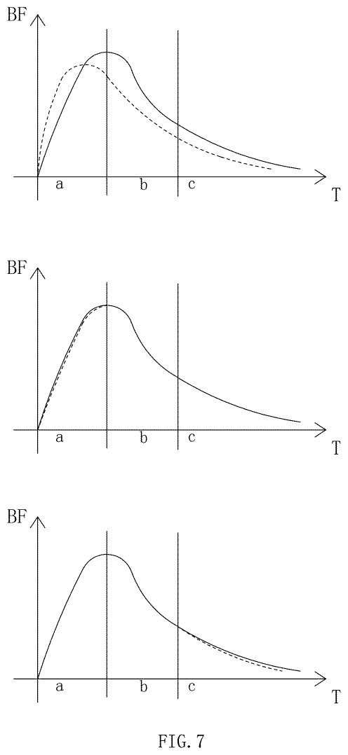

As shown in FIG. 7, this embodiment is a specific method for using the fishing reel described in any one of the above embodiments 1 to 3.

In this embodiment, the following methods are included:
S10, adjusting the driving force of all sections: operating the main operation key 7 on the reel body 1 to achieve overall adjustment of the driving force of the electromagnetic assembly in each section during the rotation and pay-off process of the spool 2;
S11, fine-tuning the driving force of the front section a: operating one of the auxiliary operation keys 8 on the reel body 1, thereby achieving, based on the driving force set in S10, a separate fine-tuning of the driving force of the electromagnetic component of the front section a during the rotation and pay-off of the spool 2;
S12, fine-tuning of the driving force of the rear section c: auxiliary operation key 8 on the reel body 1 to achieve separate fine-tuning of the driving force of the electromagnetic component of the rear section c during the rotation and pay-off of the spool 2 based on the driving force set in S10.

### Example 5

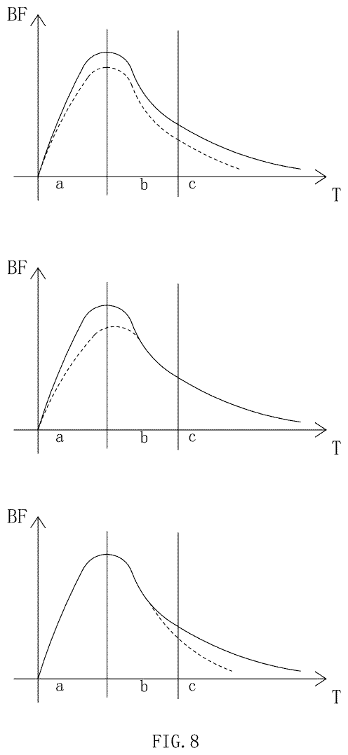

As shown in FIG. 8, this embodiment is a specific method for using the fishing reel described in any one of the above embodiments 1 to 3.

In this embodiment, the following methods are included:
S20, adjusting the driving force of the middle section b: operating the main operation key 7 on the reel body 1 to achieve separate adjustment of the driving force of the electromagnetic component of the middle section b during the rotation and pay-off of the spool 2;
the auxiliary operation keys 8 on the reel body 1 to separately adjust the driving force of the electromagnetic component of the front section a during the rotation and pay-off of the spool 2;
auxiliary operation key 8 on the reel body 1 to separately adjust the driving force of the electromagnetic component of the rear section c during the rotation and pay-off process of the spool 2.

### Example 6

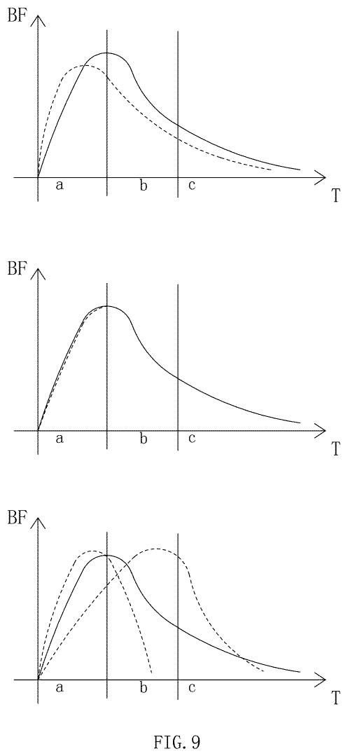

As shown in FIG. 9, this embodiment is a specific method for using the fishing reel described in any one of the above embodiments 1 to 3.

In this embodiment, the following methods are included:
S30, adjusting the driving force of all sections: operating the main operation key 7 on the reel body 1, thereby achieving overall adjustment of the driving force of the electromagnetic assembly in each section during the rotation and pay-off process of the spool 2;
S31, fine-tuning the driving force of the front section a: operating one of the auxiliary operation keys 8 on the reel body 1, thereby achieving, based on the driving force set in S10, a separate fine-tuning of the driving force of the electromagnetic component of the front section a during the rotation and pay-off of the spool 2;
S32. Drive mode adjustment: The electric control board 3 is equipped with several drive modes, and each drive mode corresponds to a preset process of rotating and paying out the spool 2. By operating another auxiliary operation key 8 on the spool body 1, the electric control board 3 can be controlled to start the built-in drive mode and switch between the various drive modes. Under the corresponding drive mode, the braking force generated by the electromagnetic component in each interval during the rotation and paying out of the spool 2 can automatically change according to the setting, so that the spool 2 rotates according to the pay-out process preset by the drive mode under the action of the electromagnetic component.

### Example 7

This embodiment is a further development of the specific working mode of the electromagnetic components in the above-mentioned embodiments 1 to 3.

In this embodiment, there are two ways of changing the driving current in the electric module 5 of the electromagnetic component; the first is to power the electromagnetic component through a power supply. In this way, a power supply needs to be built into the reel body 1 or an external power supply needs to be connected to the outside of the reel body 1; and the second is to rely on the rotation of the spool 2 when the fishing reel is manually cast, and the rotation of the spool 2 can drive the magnetic module 4 connected to the axis of the spool 2 to rotate. The rotation of the magnetic module 4 relative to the electric module 5 can generate electromagnetic induction, thereby generating an induced current at the electric module 5, and the electric control board 3 can control this part of the induced current to flow back to the electric module 5 as a driving current. In this way, even if the power supply is not set or connected inside or outside the reel body 1, the normal operation of the electromagnetic component can be achieved.

In this embodiment, since the electromagnetic component relies on the interaction between the electric module 5 and the magnetic module 4 to form a driving force, in Examples 1 to 3, the driving force is used to give the spool 2 a reverse acceleration to suppress the rotation of the spool 2 to achieve the braking purpose. Similarly, when the driving current in the electric module 5 changes its flow direction, the change in its magnetic field direction can also cause the direction of the driving force formed between the electric module 5 and the magnetic module 4 to change, thereby giving the spool 2 a positive direction and speed to promote the rotation of the spool 2 to achieve the purpose of self-rotation of the spool 2. Therefore, the electromagnetic component of this fishing reel can not only realize the braking function but also be used for the self-rotation control of the spool 2.

### Example 8

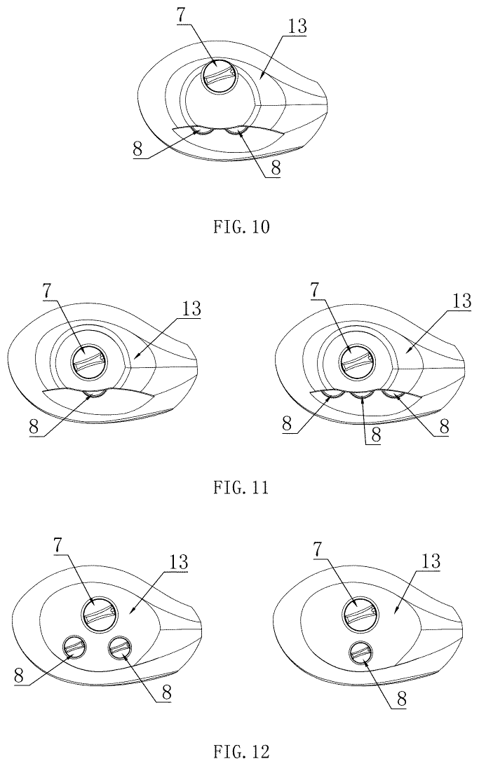

As shown in FIG. 10, the main differences between this embodiment and the first embodiment are:

In this embodiment, the main operation key 7 is not disposed in the middle of the side cover 13, but is disposed close to the edge of the side cover 13.

The remaining structures and methods of this embodiment are consistent with those of the above-mentioned embodiment 1 and will not be described again here.

### Example 9

As shown in FIG. 11, the main differences between this embodiment and the first embodiment are:

In this embodiment, the number of the auxiliary operation keys 8 is one or three.

In this embodiment, when the auxiliary operation key 8 is configured as one, the adjustment of the front section a, middle section b and rear section c during the rotation and unwinding process of the spool 2 is realized by the auxiliary operation key 8. During operation, by pressing the auxiliary operation key 8, it can switch between the three adjustment states.

In this embodiment, when there are three auxiliary operation keys 8, the three auxiliary operation keys 8 can be used to adjust the front section a, the middle section b and the rear section c during the rotation and pay-off process of the spool 2.

The remaining structures and methods of this embodiment are consistent with those of the above-mentioned embodiment 1 and will not be described again here.

### Example 10

As shown in FIG. 12, the main differences between this embodiment and the first embodiment are:

In this embodiment, the auxiliary operation key 8 is configured as a knob, and the number of the auxiliary operation key 8 can be one or more.

The remaining structures and methods of this embodiment are consistent with those of the above-mentioned embodiment 1 and will not be described again here.

### Example 11

This embodiment is an extension of the specific arrangement of the transmission member 14 between the main operation key 7 and the main control element 9 and between the auxiliary operation key 8 and the auxiliary control element 10 in the above-mentioned embodiments 1 to 3.

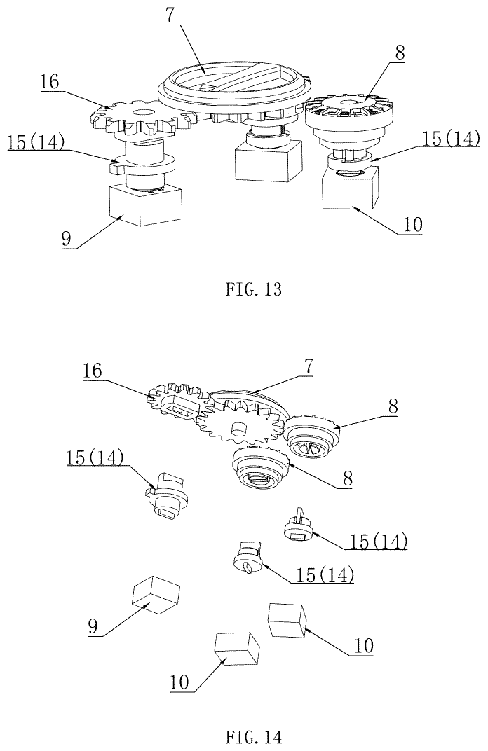

As shown in FIGS. 13 and 14, in this embodiment, the transmission member 14 is configured as a rigid connecting column 15; wherein a transmission gear 16 is further provided between the main operation key 7 and the main control component 9, and the transmission gear 16 enables transmission to be formed between the two when the axis of the main operation key 7 and the axis of the main control component 9 are staggered, and the rigid connecting column 15 also has protrusions at both ends, wherein the protrusion at the upper end is snap-fitted with the transmission gear 16, and the protrusion at the lower end is snap-fitted with the main control component 9; and the axis of the auxiliary operation key 8 coincides with the axis of the auxiliary control component 10, and the upper end protrusion of the rigid connecting column 15 between the two is snap-fitted with the auxiliary operation key 8, and the lower end protrusion is snap-fitted with the auxiliary control component 10.

The remaining structures and methods of this embodiment are consistent with those of the above-mentioned embodiment 1 and will not be described again here.

### Example 12

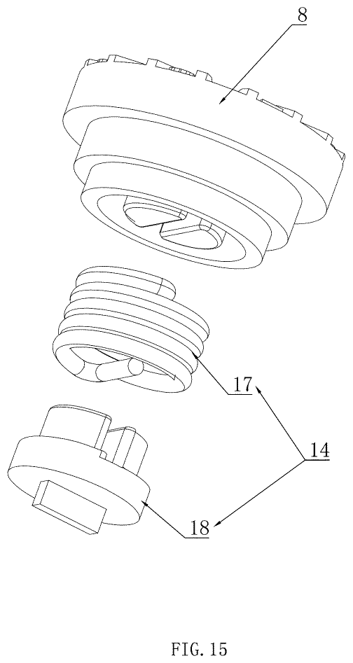

As shown in FIG. 15, the main differences between this embodiment and the above-mentioned embodiment 11 are:

In this embodiment, the transmission member 14 is configured as an elastic connection torsion spring 17 and a trigger block 18; wherein the transmission is explained by the elastic connection between the auxiliary operation key 8 and the auxiliary control element 10: the two ends of the elastic connection torsion spring 17 respectively form a snap fit with the grooves on the auxiliary operation member and the trigger block 18, and the lower side of the trigger block 18 is also provided with a protrusion that can form a snap fit with the auxiliary control element 10, thereby relying on the elastic connection torsion spring 17 and the trigger block 18 to realize the transmission between the auxiliary operation key 8 and the auxiliary control element 10; the transmission principle of the elastic connection torsion spring 17 between the main operation key 7 and the main control element 9 is consistent with the above.

The remaining structures and methods of this embodiment are consistent with those of the above-mentioned embodiment eleven and will not be described again here.

### Example 13

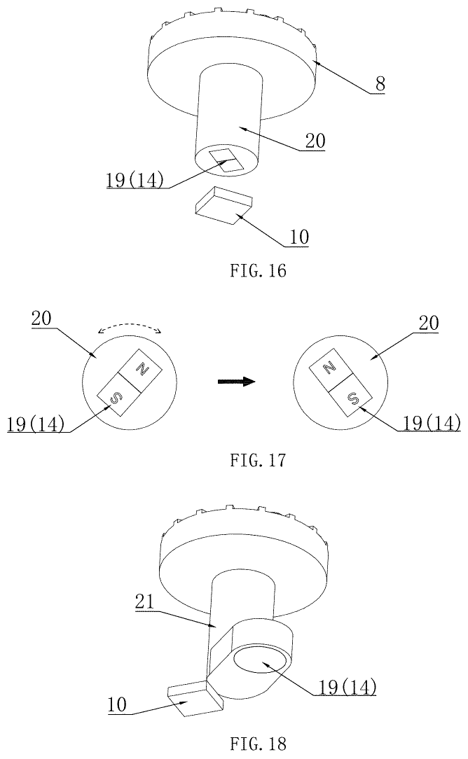

As shown in FIGS. 16 to 21, the main differences between this embodiment and the above-mentioned embodiment 11 are:

In this embodiment, the main control element 9 and the auxiliary control element 10 are both configured as magnetic sensitive elements, and the transmission member 14 is configured as a magnetic block 19. By rotating the main operation key 7 or the auxiliary operation key 8, the position state of the magnetic block 19 can be changed, and the main control element 9 or the auxiliary control element 10 can control the electric control board 3 after sensing the change in the magnetic field.

As shown in FIGS. 16 and 17, the first magnetic block 19 is set as follows: a mounting column 20 is fixedly provided on the lower side of the main operation key 7 and the auxiliary operation key 8, the axis of the mounting column 20 on the lower side of the main operation key 7 coincides with the axis of the main control element 9, and the axis of the mounting column 20 on the lower side of the auxiliary operation key 8 coincides with the axis of the auxiliary control element 10, the magnetic block 19 is embedded in the bottom of the mounting column 20, and the magnetic block 19 also includes an N pole and an S pole; the rotation of the main operation key 7 can drive the magnetic block 19 on the lower side thereof to rotate relative to the main control element 9, thereby changing the orientation of the N pole and the S pole on the magnetic block 19, and then enabling the main control component 9 to sense the change in the magnetic field direction of the magnetic block 19, and thereby control the electric control board 3 accordingly; and similarly, the rotation of the secondary operation key 8 can drive the magnetic block 19 on its lower side to rotate relative to the secondary control component 10, thereby changing the orientation of the N pole and the S pole on the magnetic block 19, and then enabling the secondary control component 10 to sense the change in the magnetic field direction of the magnetic block 19, and thereby control the electric control board 3 accordingly.

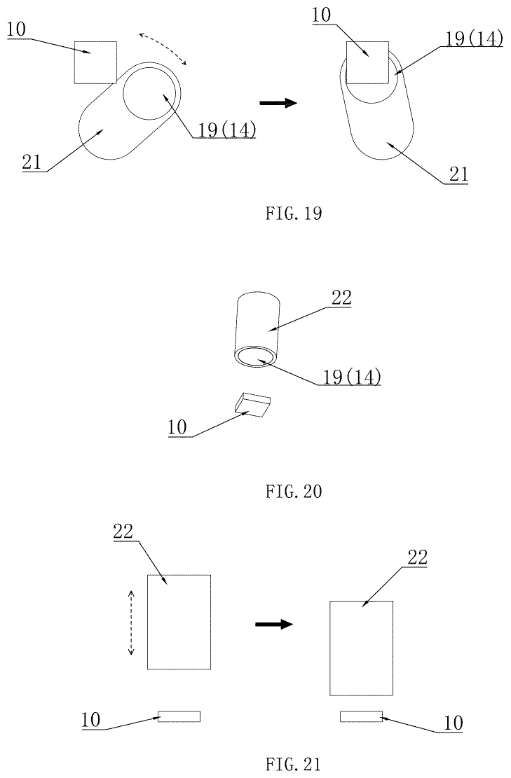

As shown in FIGS. 18 and 19, the second magnetic block 19 is arranged as follows: an eccentric column 21 is fixedly provided on the lower side of the main operation key 7 and the auxiliary operation member, the axis of the eccentric column 21 on the lower side of the main operation key 7 is staggered with the axis of the main control element 9, and the axis of the eccentric column 21 on the lower side of the auxiliary operation key 8 is staggered with the axis of the auxiliary control element 10. A protrusion is also protruded at the lower end of the eccentric column 21, and the magnetic block 19 is embedded in the bottom of the protrusion; the rotation of the main operation key 7 can drive the magnetic block 19 on its lower side to swing and move away from or approach relative to the main control element 9, so that the main control element 9 can sense the movement of the magnetic block 19 away from or approaching, and thereby control the electric control board 3; the rotation of the auxiliary operation key 8 can drive the magnetic block 19 on its lower side to swing and move away from or approach relative to the auxiliary control element 10, so that the auxiliary control element 10 can sense the movement of the magnetic block 19 away from or approaching, and thereby control the electric control board 3.

As shown in FIGS. 20 and 21, the third magnetic block 19 is provided as follows: a worm 22 is provided below the main operation key 7 and the auxiliary operation key 8, and a worm wheel is fixedly connected to the lower side of the main operation key 7 and the auxiliary operation key 8. The main operation key 7 and the auxiliary operation key 8 are connected in transmission via the worm wheel and the worm 22. The magnetic block 19 is embedded in the bottom of the worm 22. The axis of the worm 22 below the main operation key 7 coincides with the axis of the main control element 9, and the axis of the worm 22 below the auxiliary operation key 8 coincides with the axis of the auxiliary control element 10. The main operation key 7 rotates It can drive the worm 22 below it to move axially, and make the magnetic block 19 at the bottom of the worm 22 move away from or approach relative to the main control component 9, so that the main control component 9 can sense the moving away from or approach of the magnetic block 19, and thereby control the electric control board 3; the rotation of the auxiliary operating component 8 can drive the worm 22 below it to move axially, and make the magnetic block 19 at the bottom of the worm 22 move away from or approach relative to the auxiliary control component 10, so that the auxiliary control component 10 can sense the moving away from or approach of the magnetic block 19, and thereby control the electric control board 3.

The above specific embodiments are merely explanations of the disclosure and are not limitations of the disclosure. After reading this specification, those skilled in the art may make non-creative modifications to the embodiments as needed. However, as long as they are within the scope of the claims of the disclosure, they are protected by patent law.

What is claimed is:

1. A fishing reel, comprising:
a reel body;
a spool rotatably disposed in the spool body;
an electric control panel is arranged on one side of the reel body;
an electromagnetic component for generating a driving force, the electromagnetic component comprising a magnetic module and an electric module, wherein the magnetic module is connected to the spool, the electric module is arranged in the spool body and is electrically connected to the electric control board, the electric control board is capable of controlling the driving current in the electric module so that it interacts with the magnetic module to form the driving force, and the driving force acts on the spool so that the spool generates acceleration;
when the electromagnetic component imparts a positive driving force to the spool, the spool can generate a positive acceleration to promote the rotation of the spool;
when the electromagnetic component imparts a reverse driving force to the spool, the spool can generate a reverse acceleration to suppress the rotation of the spool;
wherein:
the reel body is further provided with a mechanical control module, the mechanical control module comprising at least a main operation key and a secondary operation key, the main operation key and the secondary operation key being responsive to manipulations of a user, and the mechanical control module forming a control connection with the electric control panel, so that the user can adjust the driving force generated by the electromagnetic assembly by operating the main operation key and/or the secondary operation key;
rotating the spool to pay off the line is divided into a plurality of sections, which at least include a front section and a rear section;
the mechanical control module is capable of individually adjusting the driving force generated by the electromagnetic components in each section.

2. A fishing reel according to claim 1, wherein the process of the spool rotating to release the line is divided into various intervals according to the change of the rotation speed of the spool.

3. A fishing reel according to claim 1, wherein the process of the spool rotating to release the line is divided into various intervals according to the rotation time of the spool.

4. A fishing reel according to claim 1, wherein the process of the spool rotating to release the line is divided into various intervals according to the release distance of the fishing line.

5. A fishing reel according to claim 1, wherein: the mechanical control module also includes a main control element and a sub-control element integrated on the electric control board; the main operation key forms a transmission connection with the main control element, and the sub-operation key forms a transmission connection with the sub-control element, so that the electric control board is controlled by the main operation key and the sub-operation key; the main control element can control the driving current in the electric module of one or more intervals among the several intervals, and the sub-control element respectively controls the driving current in the electric module of one interval among the several intervals.

6. A fishing reel according to claim 5, wherein: a transmission member is provided between the main operating member and the main control element, and between the auxiliary operating member and the auxiliary control element, and the transmission member is adapted to configured as a rigid connecting column, an elastic connecting torsion spring or a magnetic block; the main control element is adapted to configured as a potentiometer, a knob encoder or a magnetic sensor;
when the transmission member is configured as a rigid connecting column or an elastic connecting torsion spring, the main control element and the auxiliary control element are configured as a potentiometer or a knob encoder;
when the transmission member is configured as a magnetic block, the main control element and the auxiliary control element are configured as magnetic sensors.

7. A fishing reel according to claim 5, wherein an electronic control module is also provided in the reel body, and the electronic control module can establish communication connection with an external communication device, and the user can control the electronic control board by operating the external communication device, and then adjust the driving force of the electromagnetic component through the electronic control board.

8. A fishing reel according to claim 5, wherein the main operation key and/or the auxiliary operation key are configured as knobs, dial wheels or levers exposed on the surface of the reel body.

9. A control method, wherein it is applicable to the fishing reel according to claim 1, further comprising the following steps:
S10, adjusting the driving force of all sections: operating the main operation key on the spool body, thereby achieving overall adjustment of the driving force of the electromagnetic assembly in each section during the rotation and pay-off process of the spool;
S11, fine-tuning the driving force of the front section: operating one of the auxiliary operation keys on the reel body, thereby achieving, based on the driving force set in S10, a separate fine-tuning of the driving force of the electromagnetic component of the front section during the rotation and unwinding process of the spool;
S12, fine-tuning of the driving force of the rear section: operating another auxiliary operation key on the reel body, thereby achieving, based on the driving force set in S10, a separate fine-tuning of the driving force of the electromagnetic component of the rear section during the rotation and unwinding process of the spool.

10. A control method, wherein it is applicable to the fishing reel according to claim 1, further comprising the following steps:
S30, adjusting the driving force of all sections: operating the main operation key on the reel body, thereby achieving overall adjustment of the driving force of the electromagnetic assembly in each section during the rotation and pay-off process of the spool;
S31, fine-tuning the driving force of the front section: operating one of the auxiliary operation keys on the reel body, thereby achieving, based on the driving force set in S10, a separate fine-tuning of the driving force of the electromagnetic component of the front section during the rotation and unwinding process of the spool;
S32, drive mode adjustment: the electric control panel is built with several drive modes, and each drive mode corresponds to a preset process of the spool rotating and paying out; by operating another auxiliary operation key on the spool body, the electric control panel is adapted to controlled to start the built-in drive mode and switch between the various drive modes; under the corresponding drive mode, the braking force generated by the electromagnetic component in each interval section during the process of the spool rotating and paying out can automatically change according to the setting, so that the spool rotates according to the pay-out process preset by the drive mode under the action of the electromagnetic component.
